(19) United States
(12) Patent Application Publication
(10) Pub. No.: US 2023/0233004 A1
(43) Pub. Date: Jul. 27, 2023

(54) LOW AIR LOSS MATTRESS WITH REMOVABLE INTEGRATED PRONING HEADREST

(71) Applicant: ProneSense, Golden, CO (US)

(72) Inventor: Tanya Wiese, Prospect, KY (US)

(73) Assignee: ProneSense, Golden, CO (US)

(21) Appl. No.: 17/648,553

(22) Filed: Jan. 21, 2022

(51) Int. Cl. A47G 9/10; A47C 27/08

(52) U.S. Cl. CPC A47G 9/1054; A47G 9/1027; A47C 27/082

(57) ABSTRACT

A proning headrest includes a horizontal board; cylindrical support posts distributed on the board; two removably juxtaposed support pads resting on the support posts; and a face pad positioned parallel to and between low-profile pillows. Recessed portions on the perimeter of the support pads form a face cutout between. Next to the recessed portion of each support pad, one surface has a low-profile pillow attached. The face pad has a convoluted air bladder and a hole aligned with the face cutout. The proning headrest keeps the patient's spine in a neutral position, keeps the endotracheal tube/tracheostomy aligned, and keeps the ventilatory circuit intact while staff rotate the patient into a prone position.

### BACKGROUND OF THE INVENTION

The present invention relates to hospital beds and, more particularly, to a low air loss mattress with a removable integrated proning headrest.

Current proning headrests are made of foam, gel or plastics that sit on top of a bed or surgical table. These static materials are not adequate to prevent pressure injuries. In addition, they do not allow maintenance of a neutral spine position while in the prone position nor do they allow normal alignment of an endotracheal/tracheostomy tube to prevent kinking or dislodgment.

As can be seen, there is a need for a medical support that prevents pressure injuries, maintains a neutral spine position when the subject is prone, and enable alignment of an endotracheal/tracheostomy tube that prevents kinking or dislodgment.

### SUMMARY OF THE INVENTION

The present invention provides a mattress and headrest that improve the safety of proned patients in the intensive care unit or during spine surgery/procedures, combining “gold standard” low air loss technology with air bladders smaller than currently available to prevent pressure injury of the face during prone positioning. The inventive devices enable the spine to remain in a neutral position to protect from injury, enables endotracheal tube/tracheostomy alignment that prevents dislodgment or kinking, and enables staff to keep the ventilatory circuit intact while rotating the patient into a prone position, thus preventing aerosolization of potential contagious particles.

In one aspect of the present invention, a proning headrest is provided, comprising a horizontal board; a plurality of cylindrical support posts distributed on the horizontal board in a predetermined configuration; a first support pad removably juxtaposed to a second support pad parallel to the horizontal board and resting on the plurality of cylindrical support posts, the first support pad and the second support pad each having a perimeter with a recessed portion and a first surface adjacent to the recessed portion with a low-profile pillow coupled thereto; and a face pad having a convoluted air bladder with a face pad hole formed therethrough, said face pad being positioned parallel to and between the low-profile pillows. A face cutout forms between the recessed portions of the first support pad and the second support pad when in juxtaposed position and the face pad hole is aligned with the face cutout.

These and other features, aspects and advantages of the present invention will become better understood with reference to the following drawings, description, and claims.

### BRIEF DESCRIPTION OF THE DRAWINGS

FIG. 1 is a perspective view of a medical mattress according to an embodiment of the present invention, shown in use;

FIG. 2 is an exploded top perspective view thereof;

FIG. 3 is an exploded detail bottom perspective view thereof;

FIG. 4 is a sectional view thereof, taken along line 4-4 on FIG. 1;

FIG. 5 is a sectional view thereof, taken along line 5-5 on FIG. 1; and

FIG. 6 is a sectional view thereof, taken along line 6-6 on FIG. 5.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a low air loss mattress with a removable integrated proning headrest. The inventive mattress and headrest are sometimes referred to herein as “ProneSense”.

ProneSense may be used as a low air loss mattress known in the art for critically ill patients in the supine or lateral position to help prevent pressure induced injuries. In addition, it maintains the benefit of low air loss technology when used for a patient that requires prone positioning.

The ProneSense mattress comprises a headrest removably integrated with a low air loss body mattress. The body portion of the mattress may raise and lower the subject's upper torso to keep the spine in a neutral position while maintaining the low air loss features of the mattress. In some embodiments, additional support components may be added to raise the upper torso. The headrest comprises a headboard that partially slides horizontally under the mattress and supports a supporting structure for a low air loss pillow. The supporting structure is separable into two removable components, which may be of equal widths, i.e., halves. Each half has a recessed portion along its perimeter, e.g., in a half T-shape such that when the halves are juxtaposed, they form an open T-shape. The halves may, in some cases, have each have an angled corner such that a triangular notch is formed between the juxtaposed halves. The low air loss mattress may have a corresponding shape cut into it in a region that sits on top of the two halves. This creates an opening for access and monitoring of the eyes, nose, mouth, and for endotracheal/tracheostomy tubes. The low air loss mattress may have about 5 T-shaped one-inch bladders distributed around the open T shape.

In some embodiments, a visual monitoring device such as a camera or a mirror may be installed in the headboard and directed toward the patient's face. In some embodiments, a second camera may be installed on a side of the supporting block, e.g., to the left of the patient's face, for direct visualization of the side of the endotracheal/tracheostomy tube.

In some embodiments, a pressure sensor may be integrated into the headrest to monitor facial pressures and to provide feedback for automated air flow changes to relieve an area of harmfully high pressure. In some embodiments, the pressure sensor may be integrated into the face pad or pillow.

In some embodiments, the face pad or pillow may be disposable.

The inventive head rest may be used according to the following method. The provider may remove one half of the head rest and rotate the patient into position without opening the ventilatory circuit. Once in position, the removed half of the head rest may be replaced and the low air loss pillow may be placed over the center of the two halves.

The materials and method of manufacture are not particularly limited.

The ProneSense headrest portion may be used as a standalone headrest on top of a surgical/procedural table for procedures requiring the proned position.

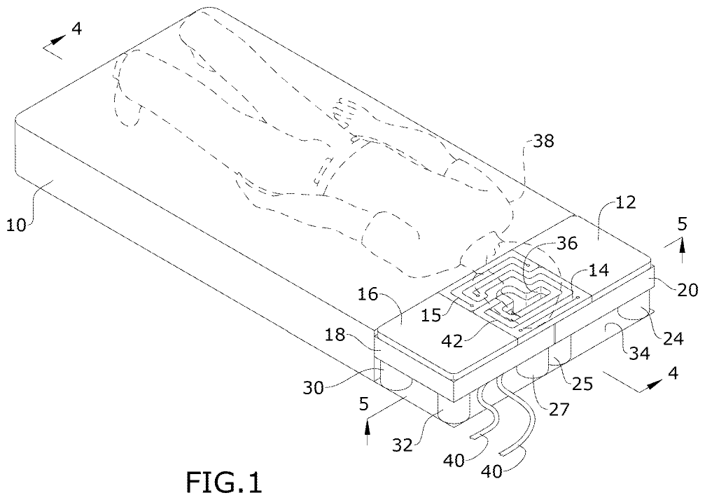

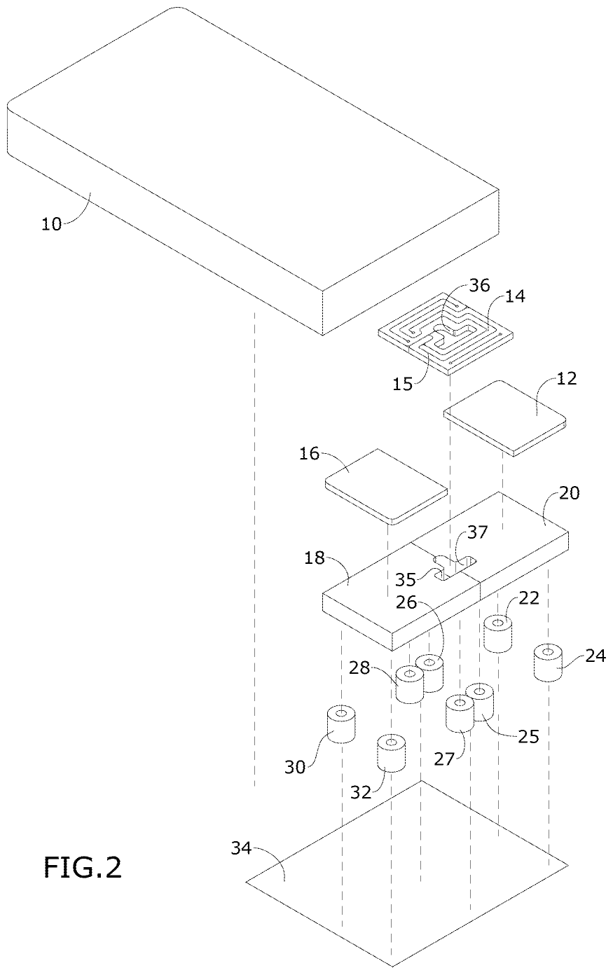

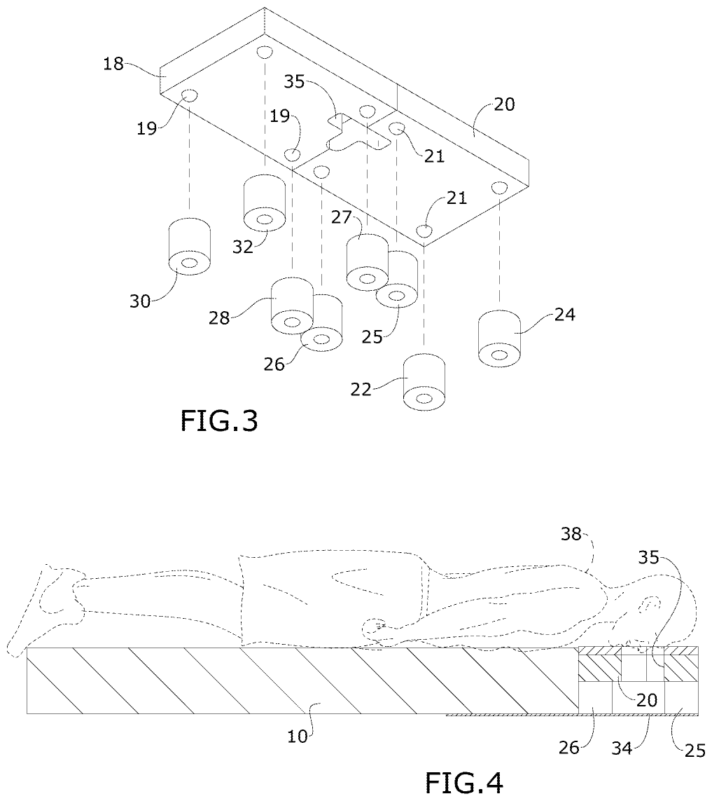

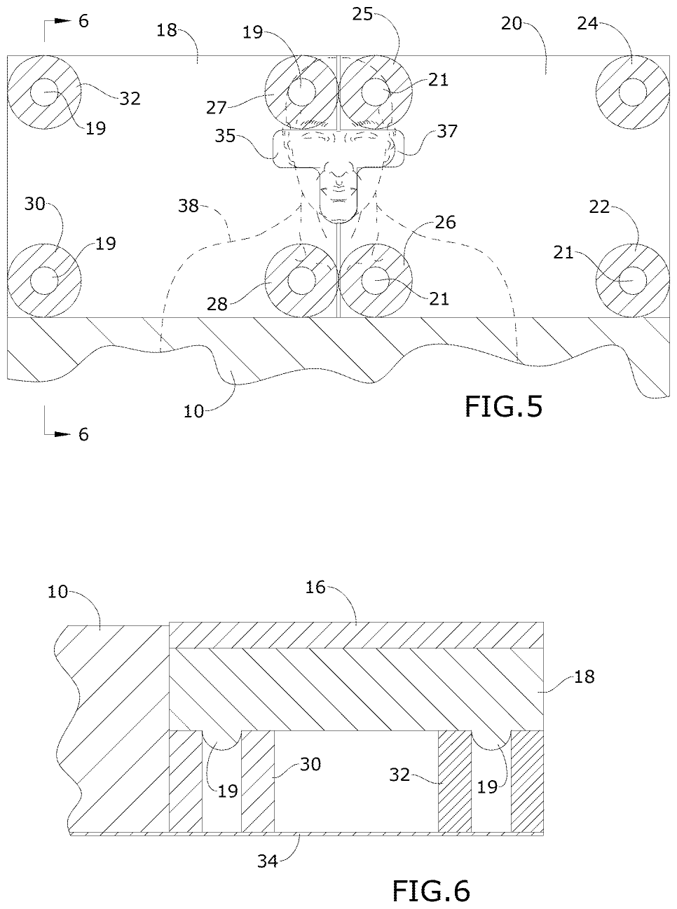

Referring to FIGS. 1 through 6, FIGS. 1, 4, and 5 illustrate the inventive mattress and headboard combination in use. A subject 38 is shown laying prone on a low air loss body mattress 10 with the subject's 38 face centered over a hole 36 through a face pad 14 and endotracheal and/or tracheostomy tubes 40 passing therethrough, emerging above a board 34 placed partially under the mattress 10. The face pad 14 has at least one convoluted air bladder 15 and is centered between a pair of low-profile pillows 12, 16. The face pad 14 and pillows 12, 16 rest on a first surface of a pair of support pads 18, 20. As seen in FIGS. 2-5, each of the support pads 18, 20 has a recessed portion forming a first face cutout 35 and a second face cutout 37. The face pad hole 36 is aligned with the face cutouts 35, 37. The support pads 18, 20 are elevated above the board 34 on a plurality of cylindrical support posts 22, 24, 25, 26, 27, 28, 30, 32 placed in a predetermined configuration as shown in FIGS. 2 and 5. The cylindrical shape of the posts protects a provider's hands when reaching underneath the support pads. As best seen in FIGS. 3 and 6, the support pads 18, 20 have alignment nubs 19, 21 on a second surface that keep the cylindrical support posts 22, 24, 25, 26, 27, 28, 30, 32 aligned.

It should be understood, of course, that the foregoing relates to exemplary embodiments of the invention and that modifications may be made without departing from the spirit and scope of the invention as set forth in the following claims.

What is claimed is:

1. A proning headrest, comprising:
a horizontal board;
a plurality of cylindrical support posts distributed on the horizontal board in a predetermined configuration;
a first support pad removably juxtaposed to a second support pad parallel to the horizontal board and resting on the plurality of cylindrical support posts, the first support pad and the second support pad each having a perimeter with a recessed portion and a first surface adjacent to the recessed portion with a low-profile pillow coupled thereto; and
a face pad having a convoluted air bladder with a face pad hole formed therethrough, said face pad being positioned parallel to and between the low-profile pillows;
wherein a face cutout forms between the recessed portions of the first support pad and the second support pad when in juxtaposed position and the face pad hole is aligned with the face cutout.

2. The proning headrest of claim 1, wherein the horizontal board couples with a low-air-loss mattress.

3. The proning headrest of claim 1, wherein the face cutout has a “T”-shape.

4. The proning headrest of claim 1, further comprising a pressure sensor.

5. The proning headrest of claim 1, wherein the horizontal board couples with a surgical table and/or a procedural table.

6. The proning headrest of claim 1, wherein the first support pad and the second support pad each have a second surface comprising a plurality of alignment nubs couplable with the plurality of cylindrical support posts.

7. The proning headrest of claim 1, further comprising a visual monitoring device attached to the horizontal board.
